(19) United States
(12) Patent Application Publication
(10) Pub. No.: US 2020/0404897 A1
(43) Pub. Date: Dec. 31, 2020

(54) DEVICE FOR TRAPPING DAMAGING FLYING INSECTS AND METHOD FOR COUNTING INSECTS TRAPPED

(71) Applicant: TECHNO BAM, SENAS (FR)

(72) Inventors: Simon LILLAMAND, MAILLANE (FR); Pierre BELLAGAMBI, MAILLANE (FR)

(73) Assignee: TECHNO BAM, SENAS (FR)

(21) Appl. No.: 16/978,366

(22) PCT Filed: Mar. 5, 2019
(86) PCT No.: PCT/FR2019/050485

§ 371 Date: Sep. 4, 2020

(30) Foreign Application Priority Data
Mar. 6, 2018 (FR) 1851929

(51) Int. Cl. A01M 1/02; A01M 1/10; A01M 1/08; G01N 15/10

(52) U.S. Cl. CPC A01M 1/026; A01M 1/106; F21S 8/086; G01N 15/10; A01M 2200/012; A01M 1/08

(57) ABSTRACT

A device for trapping damaging flying insects, including a device for diffusing an attractive gaseous cocktail, of which the composition is suitable for attracting insects, a suctioning device having an orifice for suctioning an air flow containing the insects attracted by the attractive cocktail diffused, a trap arranged with the suctioning device, and a chassis containing a gas source, which gas is a component of the attractive gaseous cocktail, where the optical insect counter includes a series of parallel deflectors installed through the suctioning orifice, a luminous barrier composed of a light transmitter and a light receiver being installed in each interval between said deflectors.

### TECHNICAL FIELD OF THE INVENTION

The invention aims for a device for trapping damaging flying insects, as well as a method for counting insects trapped.

It relates to the technical field of systems making it possible to attract and to capture damaging flying insects, in particular Nematoceran Diptera (bloodsuckers) and Hematophagous Diptera (biters) insects.

### STATE OF THE ART

In areas particularly exposed to the presence of mosquitoes, communities, tourism offices and individuals spend considerable sums to carry out preventive treatments for destroying mosquito larvae.

Various techniques for fighting against mosquitoes currently exist:

the larvicide technique: it involves the use of chemical or biological products which act on mosquitoes at the immature stage to stop the development thereof. This technique is effective for stopping the development of mosquitoes, as the larvae thereof generally occupy a minimum and easily locatable geographic space. However, it is very expensive. In addition, the frequent use of larvicides can lead to a phenomenon of habituation and of resistance to the product used.

the insecticide technique: it aims to remove adult mosquitoes with synthetic or natural chemical substances (for example, insecticides). However, this technique leads to considerable costs and involves a heavy logistic (air or land spraying). In addition, the insecticide substances can also have damaging effects on human and animal health. Moreover, the repeated use thereof has a risk of resistance.

the repellent technique: it aims to divert mosquitoes from the potential target thereof, by disturbing the tracking abilities thereof with synthetic or natural chemical substances (for example, DEET (N,N-diethyl-3-methylbenzamide). However, this technique does not generally kill mosquitoes, but pushes them back from their prey. In addition, not many long-term toxicity studies have been carried out on repellents currently available on the market.

Environmental studies demonstrate that all chemical products degrade poorly and have a tendency to be diffused into the ecosystem. In addition, they are damaging for the fauna of treated areas by impacting the bottom of the food chain, mosquito control only treats wild areas without treating urbanized areas where pests are mainly present, and where risks of viral infection linked to mosquitoes spreading are the greatest. The chemical products used reach and destroy the natural predators of mosquitoes, which aims to substantially reduce the overall effectiveness of mosquito control campaigns.

The protection of dwelling areas situated in regions infected by mosquitoes therefore moves to searching for ecologically less aggressive means.

By patent documents WO2016/020627 (TECHNO BAM), US 2009/0162253 (PORCHIA), US 2007/0006520 (DURAND), US 2004/0154213 (MOSHER) or U.S. Pat. No. 5,813,166 (WIGTON), devices which can provide a suitable alternative response, and which correspond to an actual need are known. These devices generally comprise: —a device for diffusing, in the surrounding ambient air, an attractive gaseous cocktail, of which the composition is suitable for attracting insects; —a suctioning device having an orifice for suctioning a flow of surrounding ambient air containing the insects attracted by the diffused attractive gaseous cocktail; —an insect trap arranged with the suctioning device, such that the insects suctioned by said device are retained in said trap; —a chassis containing a gas source connected to the diffusion device, which gas is a component of the attractive gaseous cocktail. This type of device is an alternative to mosquito control by larvicide.

These devices of the prior art can only generally trap a limited number of flying insect pest species. Indeed, the different species of damaging flying insects do not all fly at the same height. Some fly very close to the ground, such as tropical mosquitoes Aedes Albopictus, Aegypti or Anopheles, and others at a distance from the ground such as ornithophile mosquitoes. In the abovementioned devices, the suctioning device is generally secured to the chassis containing the gas source, such that the suctioning orifice is situated at a fixed distance from the ground. These devices therefore have a limited effectiveness when they are installed in areas where the insects fly close to the ground.

Patent document EP 1.049.373 (AMERICAN BIOPHYSICS CORP) suggests positioning the suctioning orifice at a distance from the ground comprised between 1 foot and 3 feet to capture species flying close to the ground. A hook makes it possible to suspend the device at height, to capture other species, for example some tropical species which fly in the canopy. The adjustment of the height of the suctioning orifice of this device is relatively basic, not very accurate and not very practical for the user.

Patent document WO2016/168347 (UNIVERSITY OF FLORIDA RESEARCH FOUNDATION) discloses a device for trapping insects, making it possible to detect, count, trap and discard a population of insects. The device comprises a casing producing a directional force through a narrow passage to move an insect in a predetermined direction. The device comprises one or more detectors for detecting the presence of an insect along the narrow passage. A processor monitors a counting of a population in the basket based on the detection of the presence of the insect or mosquito. The counting is carried out by means of an optical sensor combined with an audio sensor and with a video sensor. Three separate types of sensors are therefore necessary for the counting, which complexifies the design and considerably increases the costs. Furthermore, to ensure an accurate counting, it is necessary to make the insects circulate through a narrow passage. The number of insects captured must therefore be limited, if an optimal counting is desired. Also, the accuracy of the counting is done at the expense of the trapping capacity of the insects.

The invention aims to overcome the abovementioned disadvantages of the prior art. Another aim of the invention is to propose a device making it possible to accurately count the insects trapped while ensuring an optimal trapping capacity.

Another aim of the invention is to propose a device of which the effectiveness is optimal whatever the area where it is installed.

Another aim of the invention to propose a device which is practical for the user, of simple design, not very expensive, easy to use, and can easily be handled.

### DISCLOSURE OF THE INVENTION

The solution proposed by the invention is a device for trapping damaging flying insects comprising:

a device for diffusing, in the surrounding ambient air, an attractive gaseous cocktail of which the composition is suitable for attracting insects,

a suctioning device having a suctioning orifice of a flow of surrounding ambient air containing the insects attracted by the diffused attractive gaseous cocktail,

an insect trap arranged with the suctioning device, such that the insects suctioned by said device are retained in said trap.

This device is noteworthy in that the optical insect counter comprises a series of parallel deflectors installed through the suctioning orifice, a luminous barrier composed of a light transmitter and a light receiver being installed in each interval between said deflectors.

Each transmitter/receiver pair forms a detection sensor, such that the suctioning orifice is associated with a plurality of detection sensors. Whatever the size or the diameter of the suctioning orifice, it is therefore certain that each insect will be channeled towards a detection sensor and will be counted. A suctioning orifice 220 can therefore be used of relatively wide size or diameter making it possible to capture a maximum number of insects, while having a very accurate counting.

Other advantageous features of the invention are listed below. Each of these features can be considered individually or in combination with the noteworthy features defined above, and be the subject, if necessary, of one or more divisional patent applications:

Advantageously, the deflectors are spaced from one another by a distance comprised between 4 mm and 9 mm.

Advantageously, the transmitter is an infrared LED and the receiver is a photodiode.

Advantageously, the optical insect counter is situated at the start of the suctioning area of the suctioning orifice.

According to an advantageous feature of the invention, a chassis contains a gas source connected to the diffusion device, which gas is a component of the attractive gaseous cocktail; the diffusion device, the suctioning device and the insect trap form a structure connected to the chassis by way of at least one means for adjusting the height of said structure, in the direction of a gap or a convergence of the level of the ground of the suctioning orifice.

Advantageously, the means for adjusting the height is presented in the form of at least one crosspiece fixed to the structure, which crosspiece is secured to the chassis according to a plurality of vertical positions making it possible to adjust the gap or the convergence of the level of the ground of the suctioning orifice.

According to an embodiment variant, the means for adjusting the height is presented in the form of at least one crosspiece fixed to the chassis, which is secured to the structure according to a plurality of vertical positions making it possible to adjust the gap or the convergence of the level of the ground of the suctioning orifice.

Advantageously, a fluidic connection is made between the gas source installed in the chassis and the diffusion device, which fluidic connection passes through the at least one crosspiece.

An electric power source can be installed in the chassis, an electric connection being made between said source and the structure, which electric connection passes through the at least one crosspiece.

The chassis can be presented in the form of a streetlight.

Advantageously, the suctioning device comprises a heating element (240) arranged at the level of the suctioning orifice, upstream from said orifice.

This heating element is preferably heated to a temperature comprised between 35° C. and 45° C.

Advantageously, the diffusion device is controlled by a suitable control unit, such that the attractive gas cocktail is diffused in the surrounding ambient air according to a sinusoidal rhythm simulating a breathing rhythm of a human being.

This control unit is preferably suitable for making the frequency of the sinusoidal rhythm of diffusing the attractive gaseous cocktail vary.

Another aspect of the invention relates to a method for counting damaging flying insects, said method consisting of:

diffusing, in the surrounding ambient air, an attractive gaseous cocktail, of which the composition is suitable for attracting insects,

suctioning, through a suctioning orifice, a flow of surrounding ambient air containing the insects attracted by the diffused attractive gaseous cocktail,

retaining the suctioned insects in a trap,

optically counting the insects suctioned through the suctioning orifice.

The method further comprising steps consisting of:

installing a series of parallel deflectors through the suctioning orifice,

installing, in each interval between the deflectors, a luminous barrier composed of a light transmitter and a light receiver.

### DESCRIPTION OF THE FIGURES

Other advantages and features of the invention will appear better upon reading the description of a following preferred embodiment, in reference to the appended drawings, made as indicative and non-limiting examples and wherein:

FIG. 1 is a perspective view of a device according to the invention,

FIG. 2 shows the device of FIG. 1 with the diffusion device partially disassembled,

FIG. 3a is a perspective view of a foldable plate constituting the diffusion device,

FIG. 3b is a perspective view of the diffusion device obtained by the folding of the plate of FIG. 3a,

FIG. 4a is a perspective view of a foldable plate constituting the suctioning device,

FIG. 4b is a perspective view of the suctioning device obtained by the folding of the plate of FIG. 4b,

FIG. 5a is a perspective view of a foldable plate constituting the chassis containing the gas source,

FIG. 5b is a perspective view of the chassis obtained by the folding of the plate of FIG. 5b,

FIG. 6a is an expanded view of the suctioning orifice associated with an optical insect counter,

FIG. 6b schematically illustrates, as a top view, the arrangement of an optical insect counter at the level of the suctioning orifice,

FIG. 7 is a schematic, cross-sectional view of a device according to the invention,

FIG. 8 shows a device according to the invention according to an embodiment variant,

FIG. 9 is a diagram illustrating different sinusoidal rhythms for diffusing the attractive gaseous cocktail in the surrounding ambient air,

FIG. 10 schematizes a configuration of the fluidic connection and of the electric connection at the level of a crosspiece,

FIG. 11 illustrates an installation including several networked devices according to the invention.

### PREFERRED EMBODIMENTS OF THE INVENTION

The device which is the subject matter of the invention is intended to trap Nematoceran Diptera insects (bloodsuckers) such as mosquitoes and Hematophagous Diptera insects (biters of their prey) such as black flies. The principle consists of simulating the presence and the breathing of a mammal in its place. More generally, the invention aims to trap damaging flying insects. Attracted by an attractive cocktail, the targeted insects are then suctioned and captures. Thus confined, the insects can be either killed, or recovered alive, for example for a subsequent scientific study.

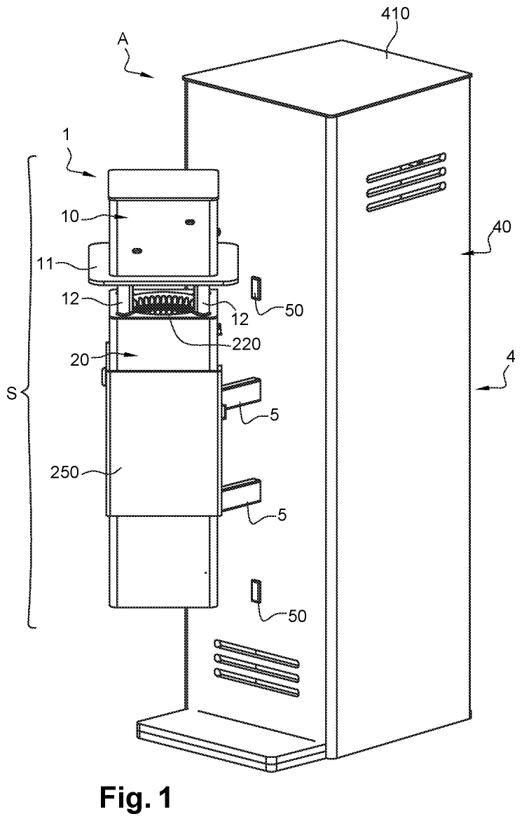

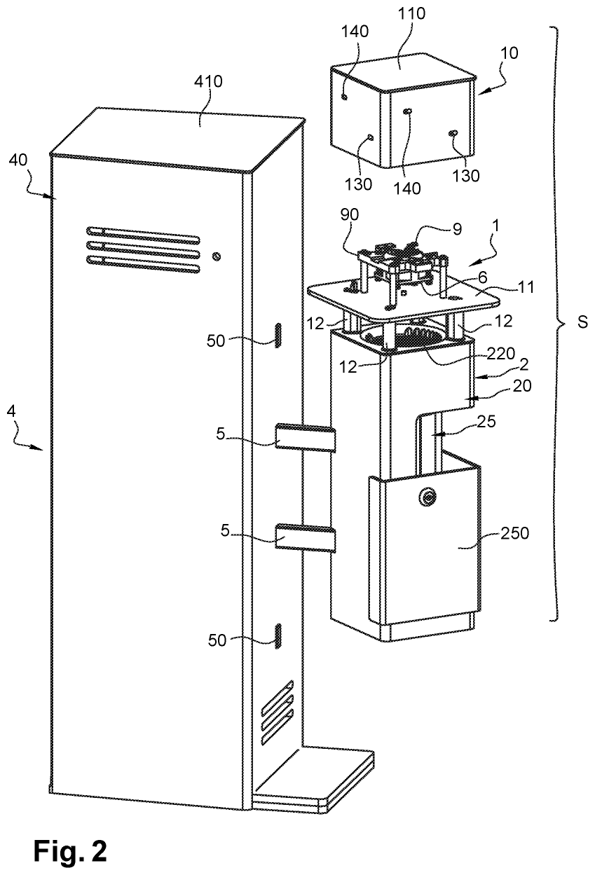

In FIGS. 1 and 2, the device A comprises:
a diffusion device 1, making it possible to diffuse in the surrounding ambient air, an attractive gaseous cocktail of which the composition is suitable for attracting insects,
a suctioning device 2 having an orifice for suctioning 20 a flow of surrounding ambient air containing the insects attracted by the attractive gaseous cocktail diffused by the diffusion device 1,
an insect trap 3 arranged with the suctioning device 2, such that the insects suctioned by said device are retained in said trap,
a chassis 4 containing a gas source connected to the diffusion device 1, which gas is an attractive gaseous cocktail. The chassis 4 is directly placed on the ground and can be provided with wheels so as to make it mobile and/or movable.

In FIG. 2, the diffusion device 1 comprises a hollow parallelepiped box 10 fixed on the plate 11 forming a cap. As an example, the box 10 has a height comprised between 10 cm and 20 cm and sides of which the length is comprised between 10 cm and 20 cm. The fixing of the box 10 on the plate 11 is preferably done by magnetization such that a user can easily separate these two elements. A fixing by screwing or snap-fitting is also possible. The plate 11 is presented in the form of a square-shaped horizontal flat plate, made of steel or of plastic, and in particular, a plastic material of the expanded polypropylene type, preferably commercialized under the brand FOAMLITE®. The sides of the plate 11 have dimensions greater than the sides of the box 10. For example, the sides of the plate 11 are twice as long as those of the box 10.

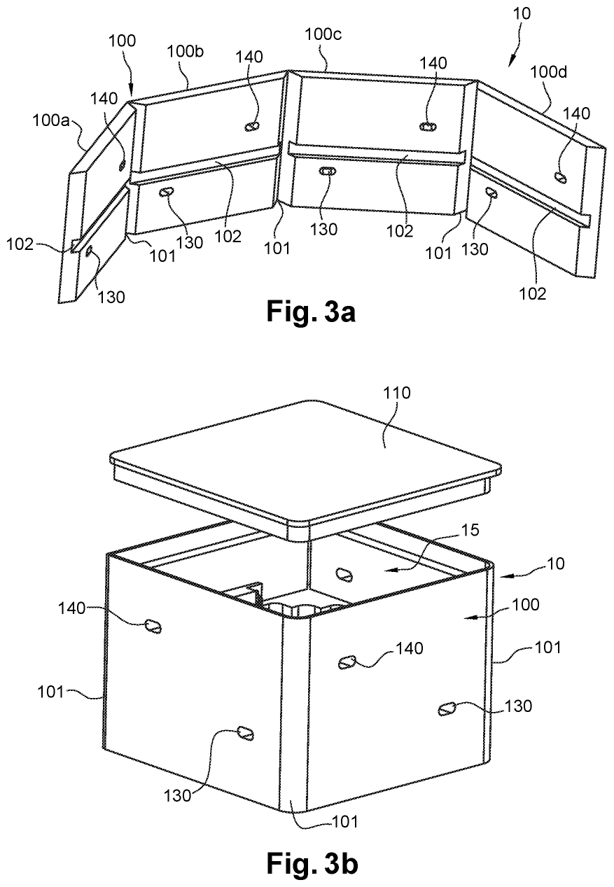

In FIGS. 3a and 3b, the box 10 is shaped from a plate 100 comprising side panels 100a, 100b, 100c, 100d connected together by folds 101 enabling the assembly thereof. Maintaining the shape of the box 10 is ensured by a fixing by gluing, welding or by interlocking side edges of the end panels 100a and 100d. A cover 110 closes the upper portion of the box 10 after assembly of it. The cover 110 is advantageously removable so as to enable an easy access inside the box 10.

The use of such a plate 100 has several advantages and in particular: a simple assembly and not requiring any specific tooling; a reduced bulk which is particularly assessable during transport and/or storage phases before assembly.

The plate 100 and the cover 110 are preferably made of plastic material of the expanded polypropylene type, preferably commercialized under the brand FOAMLITE®. This material indeed has, further to the low weight thereof, a good mechanical resistance and a good resistance to chemical attacks.

Each panel 100a-100d of the plate 100 has, on the inner face thereof (i.e. the face situated inside the box 10 after assembly of the latter), a longitudinal groove 102 wherein is housed, without another type of fixing means, the edges of a support plate as explained above in the description.

Once assembled and blocked by the cover 110, the box 10 defines a hollow chamber 15 inside which are installed the elements making it possible to dispense the attractive gaseous cocktail. The latter is preferably a mixture of CO₂ and of volatile olfactive lures. The CO₂ induces on the insects, a nervous stimulation similar to that produced by the breathing of a hot-blooded mammal. The olfactive lures used advantageously reproduce the odor of human skin. For example, octenol (C₈H₁₆O) is used, in particular, 1-octen-3-ol (CAS #3391-86-4), and/or lactic acid, these compounds giving good results. These compounds also avoid attracting non-damaging flying insects, such as bees.

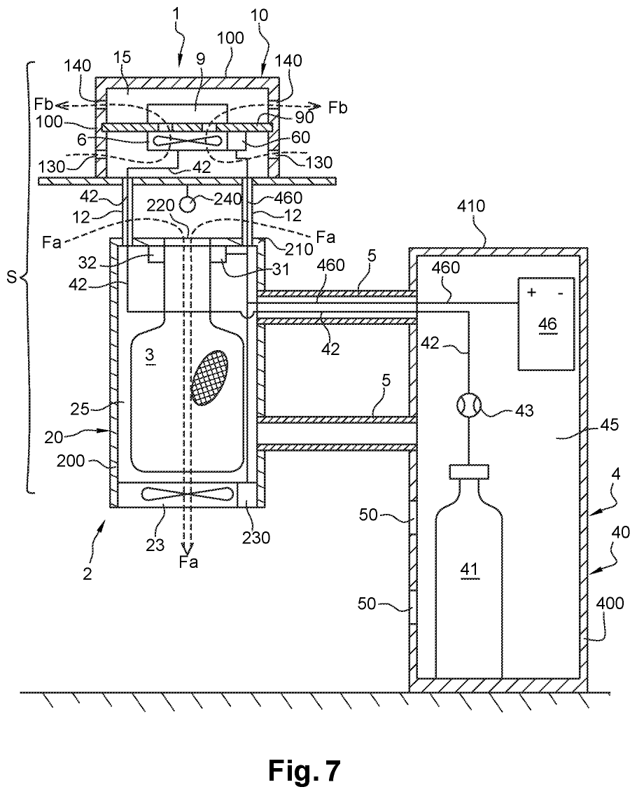

By referring more specifically to FIG. 7, olfactive lures are arranged in a removable cartridge 9, which cartridge is placed in the hollow chamber 15, above a ventilator 6. The cartridge 9 is installed on the upper face of the support plate 90 which is slotted in the longitudinal grooves 102 mentioned above. The ventilator 6 is installed on the lower face of this support plate 90. The latter thus divides the hollow chamber 15 into two areas: an upper area, wherein is installed the cartridge 9 and a lower area, wherein is installed the ventilator 6. The plate 90 has orifices or arrangements making it possible for an air circulation of the lower area towards the upper area of the hollow chamber 15.

Olfactive lures are advantageously contained or impregnated in a lure support which is placed in the flow of air Fb generated in the hollow chamber 15, by the ventilator 6. This lure support is preferably selected from among (i) a candle; (ii) a porous support such as wooden balls, utilizing the capillarity effect; (iii) a support in gel form; and (iv) a platelet made of more or less spongy absorbent material. Good results are obtained, when the lure support is porous and when olfactive lures are used in the liquid state.

In FIG. 7, the chassis 4 contains a CO₂ source 41. The latter is presented, for example, in the form of a pressurized rechargeable cylinder, of which the capacity is, for example, comprised between 0.5 kg and 50 kg. A flexible pipe 42 places the cylinder 41 and the hollow chamber 15 in fluidic communication, and more specifically the lower area of said chamber where the ventilator 6 is contained. The CO₂ is actually mixed with the air flow suctioned by the ventilator 6 and with the volatile olfactive lures arranged in the cartridge 9. A flow sensor 43 makes it possible to adjust the stream of CO₂ injected in the chamber 15. Very good results are obtained when this stream is comprised between 0.15 L/min and 0.5 L/min. According to an advantageous feature of the invention, the CO₂ is diffused continuously in the hollow chamber 15. Even when the ventilator 6 is inactive, the CO₂ is diffused in the tank 51 by passing through the vanes of said ventilator. The cylinder 41 can be associated with a sensor making it possible to alert an operator when said cylinder is empty.

Insects are both attracted by the CO₂ and the temperature of the latter is greater than the temperature of the surrounding ambient air. It can therefore be advantageous to heat the CO₂ beforehand, before the diffusion thereof. This heating can be induced naturally by the incident rays of the sun which heat the hollow chamber 15. To amplify this natural phenomenon, the hollow chamber 15 can be formed by, or contain, a refractory material (steel plates, lava stone, etc.) suitable for storing heat and returning it to the flow Fb, and therefore to the CO₂.

At the passage of the air flow Fb generated by the ventilator 6 and filled with CO₂, the olfactive lures contained in the cartridge 9 are evaporated. They are however diffused continuously in the hollow chamber 15, even in the absence of the air flow generated by the ventilator 6. This is mainly due to the fact that the hollow chamber 15 is heated by the incident rays of the sun, the temperature inside the box 10 causing a continuous evaporation of the olfactive lures inside said chamber. When the cartridge 9 is empty, it is sufficient to remove the cover 110 to remove the cartridge and replace it with another. The cartridge 9 can be associated with a sensor making it possible to alert an operator when it is empty.

The ventilator 6 is advantageously suitable for exhaling the flow Fb according to a stream comprised between 10 m³/H and 300 m³/H, preferably about 150 m³/H. It suctions the ambient air from the orifices 130 made on the panels 100a-100d of the plate 100 (FIGS. 3a, 3b and 7), under the plate 90, in the lower area of the hollow chamber 15. The flow of air suctioned by the ventilator 6 is discarded into the upper area of the hollow chamber 15, from which it emerges through the orifices 140 made on the panels 100a-100d of the plate 100 (FIGS. 3a, 3b and 7), above the plate 90. The orifices 130 and 140 open out into the surrounding ambient air and are arranged homogenously or not over the perimeter of the box 10. The attractive gaseous cocktail can thus be emptied over a wide area, in particular over an action radius of about 50 m to 60 m, corresponding to a surface of about 10000 m².

In practice, the ventilator 6 comprises a motor which pulls an electric power signature from a battery to make the vanes thereof rotate, thus generating the flow Fb. The ventilator 6 is controlled by a control unit 60 (FIG. 7) being presented, for example, in the form of an electronic board integrating a processor and/or a timeout.

The inventors have observed that the number of trapped insects when the attractive gaseous cocktail is diffused in the surrounding ambient air according to a sinusoidal rhythm simulating a breathing rhythm of a human being. Also, the control unit 60 is configured to control the ventilator 6, such that the flow Fb that it generates is in accordance with this sinusoidal rhythm. The frequency/number of cycles or periods per time unit) of the sinusoidal rhythm for diffusing the attractive gaseous cocktail can vary during a day, in order to simulate an increase in the breathing rhythm linked to a sports activity or a decrease to simulate a rest period. This frequency is preferably comprised between 10 cycles per minutes and 70 cycles per minute.

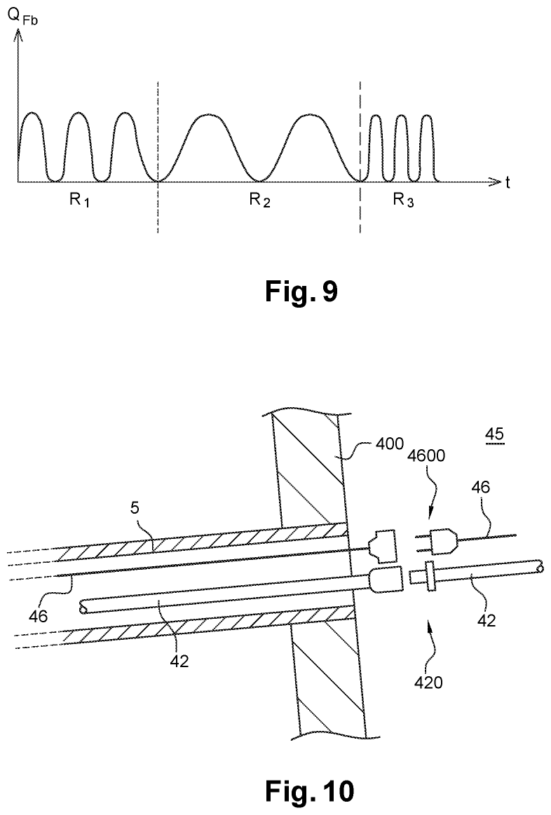

FIG. 9 is a diagram illustrating different sinusoidal rhythms for diffusing the attractive gaseous cocktail into the surrounding ambient air. The abscissas correspond to time (t) and the ordinates correspond to the stream of the flow Fb (QFb) exhaled outside of the box 10. Three sequences R1, R2 and R3 are represented. The sequence R1 simulates a breathing rhythm of an adult human being, for example comprised between 20 and 40 cycles per minute. The sequence R2 simulates a breathing rhythm of an adult human being at rest, for example comprised between 10 and 20 cycles per minute. The sequence R3 simulates a breathing rhythm of an adult human being in a period of sports activity, for example comprised between 40 and 60 cycles per minutes. In this FIG. 9, the amplitude is the same for each sequence. It can however vary from one sequence to another, even during one same sequence.

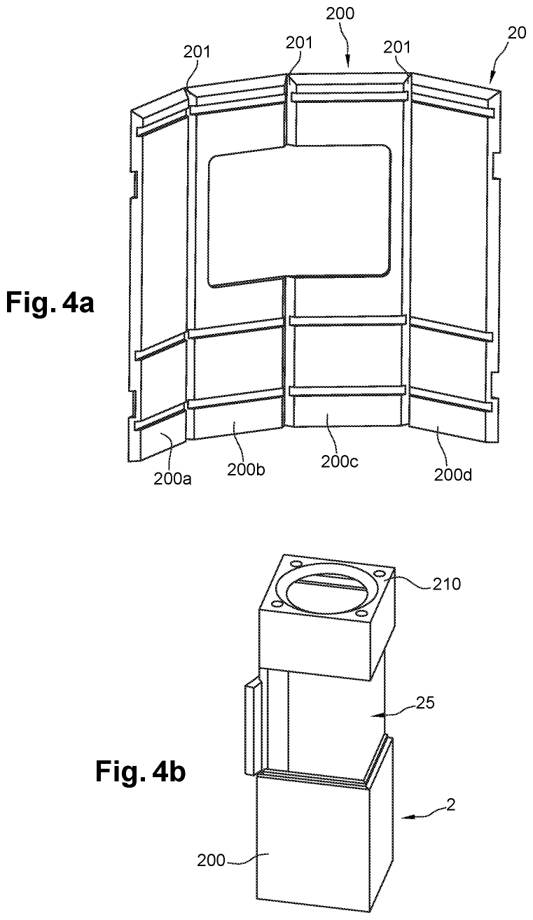

The suctioning device 2 and the insect trap 3 will now be described in more detail. In FIGS. 1 and 2, the suctioning device 2 is situated below the diffusion device 1. By referring to FIGS. 4a and 4b, the suctioning device 2 comprises a hollow parallelepiped box 20 having, as an example, a height comprised between 30 cm and 60 cm and sides, of which the length is comprised between 10 cm and 20 cm. In FIGS. 4a and 4b, the box 20 is shaped from a plate 200 comprising side panels 200a, 200b, 200c, 200d connected together by folds 201 enabling the assembly thereof. The holding in shape of the box 20 is ensured by a fixing by gluing, welding or by interlocking of the side edges of the end panels 200a and 200d. The plate 200 is also associated with a cover 210 closing the upper portion of the box 20 after the assembly of it. This cover 210 has a circular opening 220 forming a suctioning orifice and of which the diameter is, for example, comprised between 8 cm and 18 cm, this diameter range making it possible to capture a large number of insects all at once.

The plate 200 is preferably made of plastic material of the expanded polypropylene type, preferably commercialized under the brand FOAMLITE®. The use of such a plate 200 has the same advantages in terms of weight, mounting simplicity and reduced bulk than those mentioned above in reference to the plate 100.

Once assembled, the box 20 defines a hollow chamber 25 inside which is installed the insect trap 3. In FIGS. 1 and 2, a trap and/or a door 250 mounted mobile between a closed position (FIG. 1) and an open position (FIG. 2), is advantageously provided to enable an access inside the hollow chamber 25. In the appended figures, this door 250 is mounted mobile in vertical translation. It could however have a rotation movement around a hinge.

By referring to FIG. 7, the suctioning orifice 220 opens out into this insect trap 3, which trap is presented in the form of a flexible mesh or net bag. It is attached, for example, to the means of a cord or clamp ring at the level of the suctioning orifice 220. This net 3 is advantageously reusable and can be recovered and changed from the door 250. The net 2 can be associated with a sensor making it possible to indicate the filling thereof.

In FIG. 7, the suctioning device 2 comprises a suctioning means 23, being presented preferably in the form of a ventilator. This suctioning means 23 is suitable to suction the ambient air according to a stream comprised between 15 m³/H and 500 m³/H, preferably about 350 m³/H. The streams of the flows Fa and Fb are advantageously different. Indeed, the inventors have observed that more insects would be captured when the suctioned flow Fa was greater than the exhaled flow Fb.

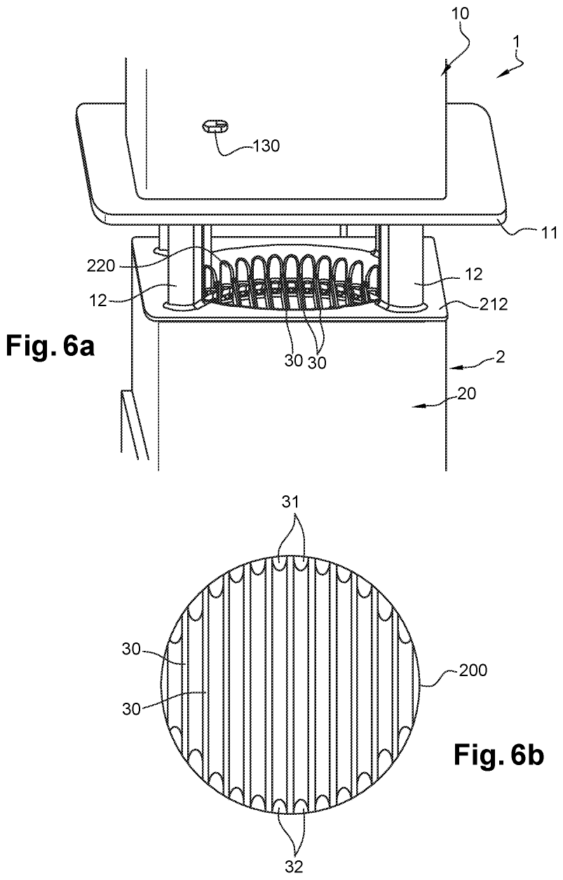

The ventilator 23 creates a depression in the box 20 and suctions the surrounding ambient air through the suctioning orifice 220, through the net 3. The flow of suctioned ambient air is schematized by the arrow referenced Fa in FIG. 7. In practice, the ventilator 23 comprises a motor which pulls an electric power signature of a battery to make the vanes thereof rotate, thus generating the flow Fa. The ventilator 23 is coupled with a control member 230 making it possible to control the operation thereof. In FIGS. 1, 2 and 7, the diffusion device 1 is situated above the suctioning device 2 and the trap 3. The plate 11 has several functions: it protects the suctioning orifice 220 from bad weather preventing, in particular, rainwater from penetrating inside the box 20 and the trap 3; it also forms a physical barrier which prevents the exhaled flow Fb filled with attractive gaseous cocktail from being recovered by the suctioned air flow Fa. According to an advantageous feature of the invention illustrated in FIGS. 6a and 6b, the suctioning device 2 is provided with an optical insect counter arranged at the level of the suctioning orifice 220. This counter comprises a series of parallel deflectors 30 installed through the suctioning orifice 220. These deflectors 30 are, for example, made of steel or of plastic.

In each interval between the deflectors 30 (or space separating two successive deflectors or spaces arranged on either side of a deflector) a luminous barrier is installed composed of a light transmitter 31 and a light receiver 32. The transmitter 31 is arranged at an end of the interval and the receiver 32, opposite, i.e. at the other end of said interval. It can also be provided to install the transmitter 31 and the receiver 32 at the level of the same end, a reflector (for example, a mirror) being arranged on the other end to reflect the light transmitted by said transmitter to said receiver. Each transmitter 31/receiver 32 pair forms a detection sensor, such that the suctioning orifice 220 is associated with a plurality of detection sensors.

To simplify the design and to limit the energy consumption of the counter, the transmitter 31 is preferably an infrared LED, and the receiver 32 is preferably a photodiode. The suctioning orifice 220 is thus “barred” by a series of luminous barriers. The deflectors 30 have the function of distributing and channeling the insects towards these luminous barriers. Whatever the size or the diameter of the suctioning orifice 220, it is therefore certain that each insect will be channeled towards a detection sensor and will be counted. A suctioning orifice 220 of relative wide size or diameter can therefore be used, making it possible to capture a maximum number of insects, while having, while having a very accurate counting.

When an insect passes between the transmitter 31 and the receiver 32, the latter is not illuminated. It is in a non-conductive state. When there is no insect which crosses the luminous barrier, the receiver 32 is directly illuminated by the transmitter 31 and is found in a conductive state. These two states are interpreted by a microcontroller by two binary states 0 or 1 which makes it possible to account for the number of insects.

Preferably, the deflectors 30 are spaced from one another by a distance comprised between 4 mm and 9 mm. This spacing makes it possible to ensure that each interval between the deflectors 30 is perfectly scanned by a luminous barrier, such that each insect passing between said deflectors is detected.

The counter is advantageously situated as close as possible to the suctioning orifice 220, at the start of the suctioning area. Indeed, in this place, the insect has a minimum falling and suctioning distance, reducing the passage speed in front of the luminous barriers, actually making the counting more accurate. This performance furthermore makes it possible to not increase measuring the sensitivity of the receiver 32, which avoids accounting for other particles (for example, dust) which can be suctioned by the suctioning device 2.

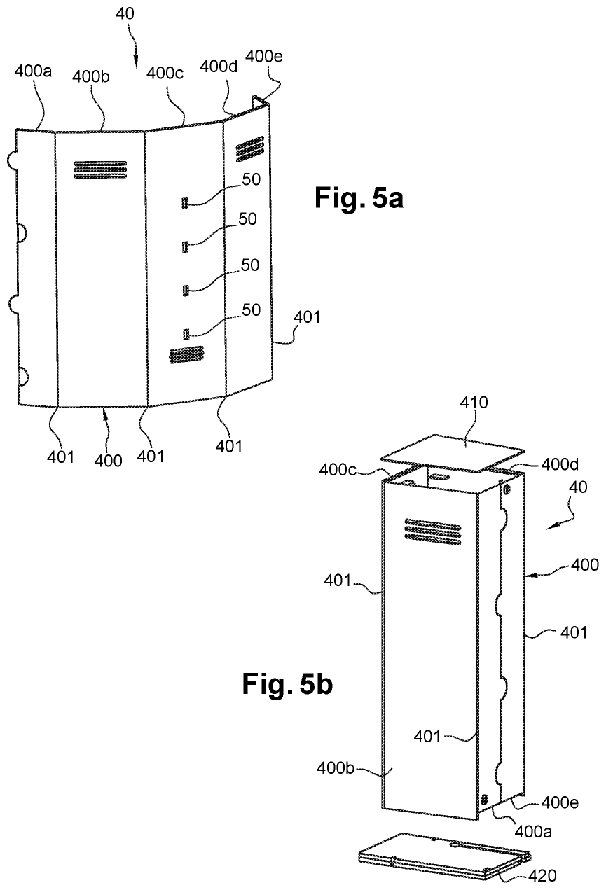

By referring to FIGS. 5a and 5b, the chassis 4 comprises a hollow parallelepiped box 40 having, as an example, a height comprised between 60 cm and 150 cm, and sides of which the length is comprised between 20 cm and 40 cm. The box 40 is shaped from a plate 400 comprising side panels 400a, 400b, 400c, 400d connected together by folds 401 enabling the assembly thereof. The holding in shape of the box 40 is ensured by a fixing by gluing, welding or by interlocking of the side edges of the end panels 400a and 400d. The box 40 is closed at the level of the upper portion thereof by a cover 410 and at the level of the lower portion thereof by a bottom plate 411. The cover 410 is advantageously removable so as to enable an easy access inside the box 40.

Once assembled, the box 40 defines a hollow chamber 45 inside which is installed the gas source 41 and an electric power source 46, for example of the battery type, suitable for supplying electricity to the different components of the device A and, in particular, the different electronic components 60, 230, 30 and the actuators 6, 23. The battery 46 can be coupled with one or more solar panels and/or wind turbines so as to make the device A autonomous. The battery 46 can also be recharged, simply by connecting it to an electric supply of the mains type. Generally, the electric power source 46 can be coupled with a timeout adjusted so as to deactivate the device A during periods where insects are not very active, for example, from midnight to 4 am.

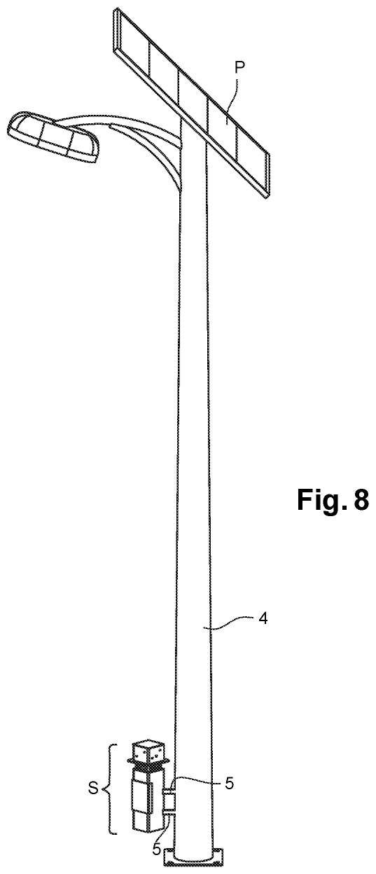

In the embodiment variant illustrated in FIG. 8, the chassis 4 is presented in the form of a streetlight. In this case, the gas source 41 is directly integrated inside the structure of the streetlight. The electric power source can consist of a battery integrated in the structure of the streetlight and/or in the electricity distribution network and/or a photovoltaic panel P and/or a wind turbine installed on the structure of said streetlight. The device A can, for example, operate, for illumination periods, thanks to the electricity distribution network, and outside of these periods, thanks to the battery, this being suitable for being recharged during illumination periods.

The operation of the device A, as well as the capturing technique will now be described in more detail. All or some of the attractive gaseous cocktail is dispensed inside the hollow chamber 15. This attractive gaseous cocktail is then expelled according to a sinusoidal rhythm into the surrounding ambient air as explained above in reference to FIG. 9. At least the olfactive lures contained in the cartridge 9, and preferably CO₂, are dispensed continuously inside the hollow chamber 15. The latter is therefore filled with attractive gaseous cocktail. The inventors have been able to demonstrate that an expulsion stream of olfactive lures comprised between 0.03 ml/day and 0.3 ml/day contributes to improving the attractive properties of the attractive cocktail. When the ventilator 6 is actuated, the air flow Fb that it generates, filled with CO₂, is mixed closely with the olfactive lures concentrated in the upper area of the hollow chamber 15, the attractive gaseous cocktail then being expelled outside of said chamber through the orifices 140.

The inventors have been able to surprisingly observe that the attractive properties of this mixture, perfectly homogenized and expelled according to a sinusoidal rhythm, were clearly improved with respect to the attractive cocktails diffused according to the techniques described in the abovementioned patent applications, and in particular according to a sequenced rhythm. The sinusoidal rhythm of these exhalations optimally excites the sensors of all Diptera and thus makes it possible to also capture bloodsuckers. The insects, attracted by this stimulus, instinctively seek to reach the area where the attractive cocktail has a maximum concentration, i.e. the hollow chamber 15.

Having arrived in the proximity of the source of the attractive cocktail, the inserts are directed towards the chamber 15. The ventilator 23 creates a continuous depression at the level of the suctioning orifice 220 and generates the air flow Fa. When, to reach the chamber 15, the insects fly in the proximity of the suctioning orifice 220, they are suctioned into the air flow Fa then retained in the trap 3.

The inventors have also observed that some stinging insects, like tropical mosquitoes, can find it difficult to finalize the course thereof to the suctioning orifice 220. Also, to further improve the attraction of these insects, the suctioning device 2 advantageously comprises a heating element arranged at the level of the suctioning orifice 220, which element simulates the body heat. In FIG. 7, the heating element 240 is situated above the suctioning orifice 220 upstream from it. This heating element 240 can be presented in the form of a heating electrical resistance. It is preferably heated to a temperature comprised between 35° C. and 45° C. This heating point makes it possible for stinging or biting insects to see a simulated body area which could facilitate the stings or bites thereof. The insects are thus guided towards a non-return area where the suctioning of the flow Fa will be stronger than the flight capacity thereof, such that they are suctioned through the orifice 220 and captured.

As illustrated in the appended figures, the diffusion device 1, the suctioning device 2 and the trap 3 form a structure S secured to the chassis 4. This structure S is distant from the chassis 4 and laterally offset from the latter.

The connection between the structure S and the chassis 4 is made from at least one means for adjusting the height of said structure in the direction of a gap or a convergence of the level of the ground of the suctioning orifice 220. This possibility to adjust the height makes it possible for the user to modulate the configuration of the device A according to the damaging flying insect species to be trapped that it will have been identified beforehand. It can thus optimally adjust the height of the suctioning orifice 220 according to the species to be treated that it will have identified, fly close to the ground or at a distance from it, actually improving the effectiveness of the device A in terms of trapping. In other words, when the user installs the device in an area to be treated, and when they have determined the damaging flying insect species to be trapped, all they need to do, is to adjust the height of the structure S. If the species to be treated fly close to the ground, the adjustment will be done in a direction of the convergence of the level of the ground of the suctioning orifice 220. On the contrary, if the species to be treated fly at a distance from the ground, the adjustment will be done in a direction of an extension from the level of the ground of the suctioning orifice 220. The device, due to this, can be considered as universal, insofar as it operates optimally in whichever geographic area, and whatever the damaging flying insect species to be trapped.

Good results making it possible to treat most damaging flying insect species are obtained when the distance “D” between the ground and the suctioning orifice 220 varies from 40 cm to 1 m. Satisfactory results are also obtained by providing three different positions for adjusting the height: a low position, where “D” is about equal to 50 cm; an intermediate position, where “D” is about equal to 65 cm; and a high position, where “D” is about equal to 80 cm. This modularity is particularly effective for tropical mosquitoes of the Aedes Albopictus, Aegypti and Anopheles type which fly close to the ground and seek to sting their prey on the low portions of the body.

According to a first embodiment illustrated in particular in FIGS. 1, 2 and 7, the means for adjusting the height is presented in the form of at least one, preferably two crosspieces 5 fixed to the structure S and more specifically fixed to the box 20 forming the suctioning device 2. In this embodiment, there is no relative movement between the crosspieces 5 and the box 20.

The crosspieces 5 are presented in the form of parallel rigid profiles, arranged horizontally or, in other words, normal to the walls of the boxes 20 and 40. The cross-section thereof can be square, rectangular, round, oval, or other, and they are advantageously made of steel or of plastic. The length thereof is, for example, comprised between 10 cm and 30 cm, such that the structure S is substantially distant from the chassis 4 by this same length. Each crosspiece 5 can be made of one single part obtained by extrusion, molding, or machining, or made of two parts assembled together, along the median plane of said crosspiece. The fixing of the crosspiece 5 on the wall of the box 20 is done at the level of the distal end of said crosspiece, by screwing, bolting, snap-fitting or by means of a flange.

Each crosspiece 5 is secured to the chassis 4 according to a plurality of vertical positions making it possible to adjust the gap or the convergence of the level of the ground of the suctioning orifice 220. These different vertical positions are materialized by recesses or housings 50 made in at least one wall of the box 40 forming the chassis 4. These recesses or housings 50 are preferably through-hole and have a cross-section which corresponds to that of the crosspieces 5. The proximal end of the crosspieces 5 are thus housed by interlocking in a recess or housing 50. A holding in position of the crosspieces 5 in the recesses or housings 50 can be ensured by a solution by screwing, bolting, or snap-fitting of the proximal end of said crosspieces in the wall of the box 40.

The recesses or housings 50 are arranged in a column and there are four of them in the appended figures. The number thereof can however vary from 2 to 10, according to the number of crosspieces 5 used and/or of the desired adjustment of the height. In an embodiment variant, the adjustment of the height is done at the level of the structure S. The crosspiece(s) 5 is/are here fixed to the chassis 4 and more specifically, to the box 40, without relative movement between said crosspieces and said box. Each crosspiece 5 is secured to the structure S according to a plurality of vertical positions making it possible to adjust the gap or the convergence of the level of the ground of the suctioning orifice 220. The recesses or housings 50 described above are thus made in at least one wall of the box 20 forming the suctioning device 2, such that the distal end of a crosspiece 5 being housed by interlocking in one of said recesses according to the position for adjusting the chosen height.

According to an advantageous feature of the invention, a fluidic connection between the gas source 41 and the diffusion device 1 passes through at least one crosspiece 5. Likewise, an electric connection between the electric power source 42 and the structure S passes through at least one crosspiece 5. The fluidic connection and the electric connection can pass through the same crosspiece 5 or into separate crosspieces.

The crosspiece 5 thus offers a physical protection to these connections. Furthermore, the fact that the crosspiece 5 acts as a support for these connections, facilitates the modularity of the device A during the adjustment of the height of the suctioning orifice 220, in particular the connection and the supply of gas and electricity from the attractive and suctioning portion (structure S) to the technical portion (chassis 4).

To simplify the design, the crosspiece 5 has a hollow conduit opening out to the two ends thereof and wherein are housed fluidic and electric connections. More specifically, the distal end thereof opens out into the hollow chamber 25 of the box 20 and the proximal end thereof opens out into the hollow chamber 45 of the box 40.

In FIG. 7, the pipe 42 connected to the cylinder 41 runs inside the crosspiece 5, passes into the hollow chamber 25 of the box 20 and opens out into the lower area of the chamber 15 of the diffusion device 1. Also, an electric cable 460 connected to the battery 46 runs inside the same crosspiece 5 and opens out into the hollow chamber 25 so as to be able to supply the different electronic components 60, 230, 30 and the actuators 6, 23 contained in the structure S. Thus, very simply and totally securely, the fluidic and electric connection between the chassis 4 and the structure S which are perfectly protected and made inaccessible.

When the user makes the height of the structure S vary, they are brought to disengage the crosspieces 5 of recesses or housings 50 to reposition them in other recesses or housings. To facilitate this handling, it appear advantageous to provide dismountable connectors for the pipe 42 and the electric cable 460. By referring to FIG. 10, the pipe 42 is provided with a dismountable connector 420 of the rapid connector type and the electric cable 460 of a dismountable electric connector 4600 of the male/female type. These connectors 420, 4600 are situated at the level of the proximal end of the crosspiece 5 and accessible from inside the chamber 45 of the chassis 4.

Thus, to modify the position of the crosspieces 5, all the user needs to do, is to disconnect the connectors 420, 4600; disengage the crosspiece 5 from the recess or housing wherein it is slotted; reposition the crosspiece 5 in another recess or housing; and finally reconnect the connectors 420, 4600.

In FIGS. 1 and 2, the diffusion device 1 is maintained at a distance from the suctioning orifice 220 by way of spacers 12. The latter consist of hollow tubes, of which the length is, for example, comprised between 2 cm and 15 cm and which are fixed, on the one hand, on the cover 210 of the box 20 and, on the other hand, to the plate 11 around the suctioning orifice 220. To supply the diffusion device 1 with gas and electricity, it is observed in FIG. 7 that the pipe 42 and the electric cable 460 pass through these spacers 12, such that the fluidic and electric connections between the box 20 and the diffusion device 1 are perfectly protected and made inaccessible.

By having a plurality of these devices A in carefully chosen places, a protective belt can be formed around a small urban community or also an open public space, thus making it possible to preserve them from damage due to the targeted damaging insects. Of course, the CO₂ supply can be specific to each device A or be common to several devices.

The device A (or each of the devices) advantageously comprises an electronic board suitable for ensuring the autonomous or programmed operation thereof. This electronic board can, for example:

controlling operating ranges of the device A (or each of the devices);

and/or toggle the electric power from the device between the battery 46 and an electric distribution network;

and/or receive an electronic signal including atmospheric data in relation to the environment wherein the device A is located; process this electronic signal; and control the interruption of the operation of the device A when the electronic signal includes atmospheric data which are not favorable for trapping damaging flying insects. The atmospheric data in question can be the external temperature, the external humidity rate, the atmospheric pressure, the wind speed, and other. These data can directly come from sensors placed outside of the device A or originate from local or regional weather stations;

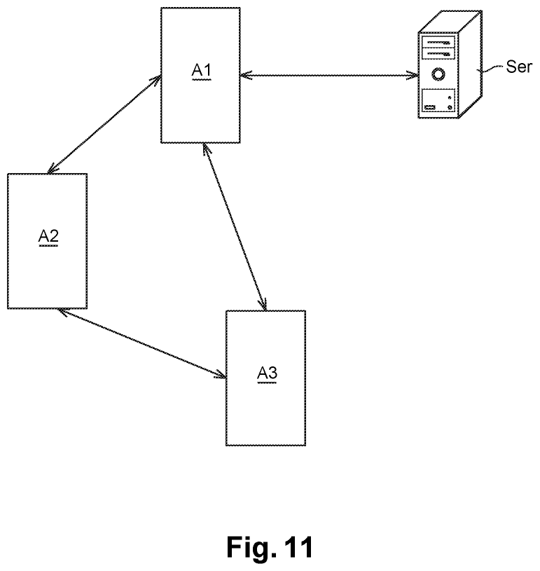

and/or make it possible for the devices A to communicate together. To this end, by referring to FIG. 11, when several devices A1, A2, A3 are networked and are suitable for communicating together, it can be advantageous that one of the devices A1 is considered as a master and the others as slaves. The master device A1 collects the information and/or data coming from the slave devices A2, A3 and communicates them to a remote server Ser. A communication solution of Lora® type is preferably used to facilitate the internal dialogue between the devices A1, A2 A3. The communication between the master device A1 and the remote server Ser is achieved using wireless communication means of the WIFI, 3G, or other type. This topology have proven to be particularly useful in geographic areas of low network coverage, since this limits the only master device A1 with the number of necessary network points on the installation;

and/or remotely manage the operation of the device(s) A, for example using wireless communication means of the WIFI, 3G, or other type;

and/or recover messages of malfunction of the device A to a remote server, in view of a rapid management of the possible malfunctions.

The arrangement of the different elements and/or means and/or steps of the invention, in the embodiments described above, must not be comprised as requiring such an arrangement in all the implementations. In any case, it will be understood that various modifications can be applied to these elements and/or means and/or steps, without moving away from the sense and the scope of the invention. In particular:

The boxes 10, 20, 40 are not necessarily of parallelepiped shape, but can be of polygonal, cylindrical shape, etc.

The suctioning orifice 220 can be circular, oval, rectangular, square, etc.

The chassis 4 is not necessarily of parallelepiped or cylindrical shape. It can be of any other shape suitable for a person skilled in the art.

The suctioning means 23 can be presented in the form of a vacuum pump.

The means 6 for generating the flow Fb can be presented in the form of an opening mechanically actuated or in the form of a pump.

CO₂ can be diffused according to a sinusoidal rhythm in the hollow chamber 15, for example according to the same rhythm as the operation of the ventilator 6.

CO₂ constituting the attractive gaseous cocktail can be replaced by any other gas suitable for a person skilled in the art.

The olfactive lures can be used in the form of gas.

An electric resistance can be provided to heat the inside of the hollow chamber 5 and if necessary, the refractory material that it contains.

The counting of insects can be ensured by other detectors installed between the deflectors 30, like passive infrared sensors (or Passive Infrared Sensor (PIR) sensor) suitable for detecting the infrared radiations transmitted by the insects passing between said deflectors.

1-15. (canceled)

16. A device for trapping damaging flying insects comprising:
a device for diffusing, in the surrounding ambient air, an attractive gaseous cocktail of which the composition is suitable for attracting insects,
a suctioning device having a suctioning orifice of a flow of surrounding ambient air containing the insects attracted by the diffused attractive gaseous cocktail,
an insect trap arranged with the suctioning device, such that the insects suctioned by said device are retained in said trap, and
an optical insect counter,
wherein the optical insect counter comprises a series of parallel deflectors installed through the suctioning orifice, a luminous barrier composed of a light transmitter and a light receiver being installed in each interval between said deflectors.

17. The device according to claim 16, wherein the deflectors are spaced from one another by a distance comprised between 4 mm and 9 mm.

18. The device according to claim 16, wherein the transmitter is an infrared LED and the receiver is a photodiode.

19. The device according to claim 16, wherein the optical insect counter is situated at the start of the suctioning area of the suctioning orifice.

20. The device according to claim 16, wherein:
a chassis contains a gas source connected to the diffusion device, which gas is a component of the attractive gaseous cocktail,
the diffusion device, the suctioning device and the insect trap form a structure connected to the chassis by way of at least one means for adjusting the height of said structure, in the direction of a gap or a convergence of the level of the ground of the suctioning orifice.

21. The device according to claim 20, wherein the means for adjusting the height is presented in the form of at least one crosspiece fixed to the structure, which crosspiece is secured to the chassis according to a plurality of vertical positions making it possible to adjust the gap or the convergence of the level of the ground of the suctioning orifice.

22. The device according to claim 20, wherein the means for adjusting the height is presented in the form of at least one crosspiece fixed to the chassis, which crosspiece is secured to the structure according to a plurality of vertical positions making it possible to adjust the gap or the convergence of the level of the ground of the suctioning orifice.

23. The device according to claim 21, wherein a fluidic connection is made between the gas source installed in the chassis and the diffusion device, which fluidic connection passes through the at least one crosspiece.

24. The device according to claim 20, wherein an electric power source is installed in the chassis, an electric connection being made between said source and the structure, which electric connection passes through the at least one crosspiece.

25. The device according to claim 20, wherein the chassis is presented in the form of a streetlight.

26. The device according to claim 16, wherein the suctioning device comprises a heating element arranged at the level of the suctioning device, upstream from said orifice.

27. The device according to claim 26, wherein the heating element is heated to a temperature comprised between 35° C. and 45° C.

28. The device according to claim 16, wherein the diffusion device is controlled by a control unit suitable such that the attractive gaseous cocktail is diffused into the surrounding ambient air according to a sinusoidal rhythm simulating a breathing rhythm of a human being.

29. The device according to claim 28, wherein the control unit is suitable for making the frequency of the sinusoidal rhythm for diffusing the attractive gaseous cocktail vary.

30. A method for counting damaging flying insects, comprising:
diffusing, into the surrounding ambient air, an attractive gaseous cocktail, of which the composition is suitable for attracting insects,
suctioning, through a suctioning orifice, a flow of surrounding ambient air containing the insects attracted by the attractive gaseous cocktail diffused,
retaining the suctioned insects in a trap,
optically counting the insects suctioned through the suctioning orifice,
installing a series of parallel deflectors through the suctioning orifice, and
installing, in each interval between the deflectors, a luminous barrier composed of a light transmitter and a light receiver.
